(19) United States
(12) Patent Application Publication
(10) Pub. No.: US 2022/0176971 A1
(43) Pub. Date: Jun. 9, 2022

(54) Driver Improvement

(71) Applicant: Christian Nordh, Coral Gables, FL (US)

(72) Inventor: Christian Nordh, Coral Gables, FL (US)

(21) Appl. No.: 17/112,987

(22) Filed: Dec. 5, 2020

(51) Int. Cl. B60W 40/09; B60W 50/14; G06Q 10/06

(52) U.S. Cl. CPC B60W 40/09; B60W 50/14; G06Q 10/06393; B60W 2540/227; B60W 2540/30; B60W 2540/229; G06Q 10/06398

(57) ABSTRACT

A driver improvement system and method where a driver's efficiency, for example in effective regenerative braking, is scored and recorded. Incentives may be provided to the driver or the fleet operator for which the driver works to encourage more efficient driving. The driver's score is portable to that the score moves with the driver from employer to employer.

### CROSS-REFERENCES TO RELATED APPLICATIONS

None.

### STATEMENT REGARDING FEDERAL SPONSORED RESEARCH OR DEVELOPMENT

None.

### NAMES OF PARTIES TO A JOINT RESEARCH AGREEMENT

None.

### REFERENCE TO A “SEQUENCE LISTING”, A TABLE, OR A COMPUTER PROGRAM LISTING APPENDIX SUBMITTED ON COMPACT DISC AND INCORPORATION-BY-REFERENCE OF THE MATERIAL ON THE COMPACT DISCLOSURE

None.

### STATEMENT REGARDING PRIOR DISCLOSURES BY AN INVENTOR OR JOINT INVENTOR

None.

### BACKGROUND OF THE INVENTION

### 1. Field of the Invention

The present invention relates to improving driving vehicles, and more particularly, to an improved device and method to aid drivers improving their driving techniques.

### 2. Description of Related Art Including Information Disclosed Under 37 CFR 1.97 and 37 CFR 1.98

Several designs for driver improvement have been designed in the past. None of them, however, includes monitoring combined with driver incentives to reduce energy consumption, improve efficiency and reduce wear that is particularly suited to electrically powered vehicles and that also allows portability of driver quality and skill metrics so that information is controllable by the driver.

Applicant believes that the closest reference corresponds to currently used systems that track a driver's location and speed to monitor the driver's location and adherence to speed limit laws. However, it differs from the present invention because the present system looks at and integrates additional monitoring metrics to factor in how efficient the driver operates the vehicle while providing improvement incentives where all the information gathered and derived data is portable and owed by a specific driver.

Other patents describing the closest subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### BRIEF SUMMARY OF THE INVENTION

It is one of the main objects of the present invention to provide an array of devices and a system of analysis to measure and monitor a driver's safety and efficiency.

It is another object of this invention to provide a portable set of information about the driver that can be carried with the driver and can be applied, for example, to different employers, insurers and vehicles.

It is still another object of the present invention to provide understandable guidance to improve a driver's skills and to develop proof of improved driving efficiency.

It is yet another object of this invention to provide such a device and method of use that are inexpensive to manufacture and maintain while retaining effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING

With the above and other related objects in view, the invention exists in the details of construction and combination of parts as will be more fully understood from the following description, when read in conjunction with the accompanying drawings in which:

FIG. 1 shows a diagram of an example of multiple driver information as it relates to multiple employment conditions.

FIG. 2 shows a stylized plan view of an example of a system in operation.

FIG. 3 shows a diagram of an example of aspects of a system as may be deployed.

### DETAILED DESCRIPTION OF THE INVENTION

While this invention may be embodied in many different forms, there are described in detail herein specific embodiments of the invention. This description is exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of use is sometimes referred to as the device, the invention, the driver improvement system, the system, the application, the process, the machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

Electric vehicles are increasing in population on the roadways of North America. Some electric vehicles used regenerative braking to recoup electrical power during the braking process. During regenerative braking the vehicles motors generate power when turning without being supplied by electrical energy. In common gasoline vehicles brakes are used to slow down without generating any electricity. In electric vehicles or hybrid vehicles energy can be saved by avoiding the brakes during slowdown and instead using regenerative braking to slow the vehicle.

Drivers who are more familiar with conventional gasoline vehicles tend to use the brakes alone for slowing the vehicle. As a driver transitions to electrical vehicles, where regenerative braking is available, old habits need to be amended. Instead of applying the brakes to slow down, the driver can save energy by remaining off the brakes and allowing the drive motors to turn to generate energy while slowing the vehicle rather than wasting that energy as heat.

Regenerative braking requires the driver to anticipate the slowdown so that the vehicle can be slowed with only the minimal application of traditional friction brakes. The energy savings can be compounded by limiting the overall speed of the vehicle. This can allow regenerative braking to be the primary means to slow the vehicle. Of course, in an emergency traditional brakes can still be freely used for rapid deceleration as needed.

Just using these two examples of slowing down of the speed of the vehicle combined with the use of regenerative braking can significantly conserve electrical energy needed to move the vehicle. If drivers can be encouraged and trained to maximize the benefits of these techniques the cost of operating the vehicle and the societal cost of burning carbon fuels can both be reduced.

When a vehicle can monitor for and recognize regenerative braking as a function of average speed the effectiveness of the driver at using regenerative braking can be measured. With this information the driver can be shown how efficiently they are employing regenerative braking techniques. When a driver knows how efficiently or inefficiently they are using regenerative braking they may be able to modify their habits to improve the efficiency.

In this sense the system creates the gamification of driving behavior. By providing an empirical score of regenerative braking efficiency the driver can play a game against themselves in an attempt to improve the efficiency of their driving. As good habits are learned and reinforced by the system providing immediate feedback as to the efficiency of regenerative braking the driver inherently becomes more efficient in the operation of the vehicle.

The information as to the overall efficiency of a driver for data collected over a protracted period of time may also be provided to an employer. The employer may then provide a reward or other incentive to encourage efficient behavior of its drivers. In this example, the efficient driving habits of the driver both make the driver money by the reward and save her employer money by reducing wear and fuel costs needed to operate that vehicle.

Similarly, this information can be provided to an insurer of the vehicle. As a driver learns to be more efficient and more conscious of their driving habits and patterns they will also become a safer driver. The insurance company can incentivize safe driving by offering lower premium rates for drivers that are safer and inherently more efficient.

The driving information of a single driver may be used for such incentives. Similarly, the averages of a fleet may also be used to affect the premium rates paid for fleet insurance. The driving efficiency information of one fleet could also be compared to other fleets or other subsections of drivers. For example, full-time drivers compared to part-time drivers or drivers of particular age ranges can be compared in an attempt to achieve maximum fleet efficiency.

Referring now to the drawings, where the present invention is generally exemplified in the drawings, it can be observed that it basically includes company A 12, company B 14, a driver Z 16, a section 18, a section 20, a driver Y 22, a driver X 24, a section 26, a signal 28, a vehicle 30, a satellite 32 and signal 34, a base 36, electric vehicles 38, telematics 40, a vehicle owner profile 42, a driver profile 44, a drive score system 46, a relation 48, a relation 50 and a relation 52.

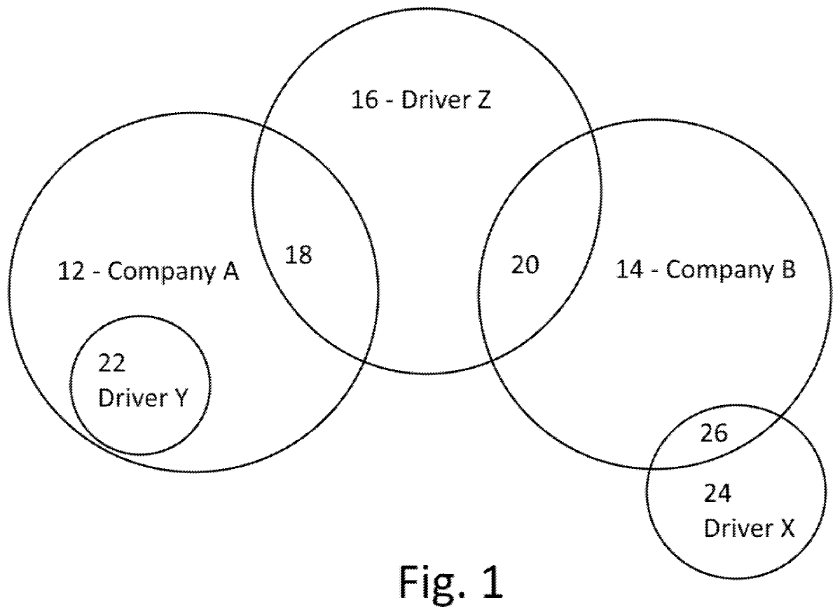

Looking now at FIG. 1, a diagram is shown representing an example of the system. Driver Z 16 is at the center of the diagram and it represents a theoretical driver participating in the system. Company A 12 employs drivers the 16 part-time as represented by section 18. Simultaneously, company B 14 also employs driver Z 16 part-time as represented by section 20. Sections 18 and 20 represent information regarding driver Z 16 for each company A 12 and company B 14 independently.

Driver Y 22 provides her driving data exclusively to company A 12. In this example, driver Y 22 is employed solely by company A 12. Driver X 24 interacts with complete B 14 on a non-exclusive basis represented by section 26.

Generally, the invention includes devices in means to monitor the vehicle use characteristics of an individual driver. Basic information such as vehicle speed, regenerative braking, hard maneuvers, acceleration, GPS derived location and driver engagement or attention are derived from available sensors associated with the vehicle.

A vehicle involved in the system may have integrated into the electronic system measuring devices such as speedometer, accelerometer, global positioning system (GPS) data, fuel consumption rate, battery charge status, battery discharge rate, imaging of the driver and other commercially available devices for monitoring.

In one aspect of the invention battery maintenance and preservation is monitored and improved. For modern battery chemistries battery life is lessened by complete and full charging followed by complete discharging. In other words, charging and then fully draining a battery can cause the battery to hold less charge on subsequent charging cycles.

Batteries tend to be able to hold a charge through more recharge cycles when they are recharged when at partial capacity. For example, certain types of batteries used in vehicles are better suited to be depleted to about twenty to fifty percent when brought up to a full charge instead of waiting to charge until the battery is fully depleted.

When the system provides for reminding a driver to recharge at predetermined points and monitoring driver compliance the driver will be encouraged to treat the battery better and charge before excessive discharge is achieved. The better the driver treats the battery, the better the driver's credit or score is improved through gamification of battery charge optimization.

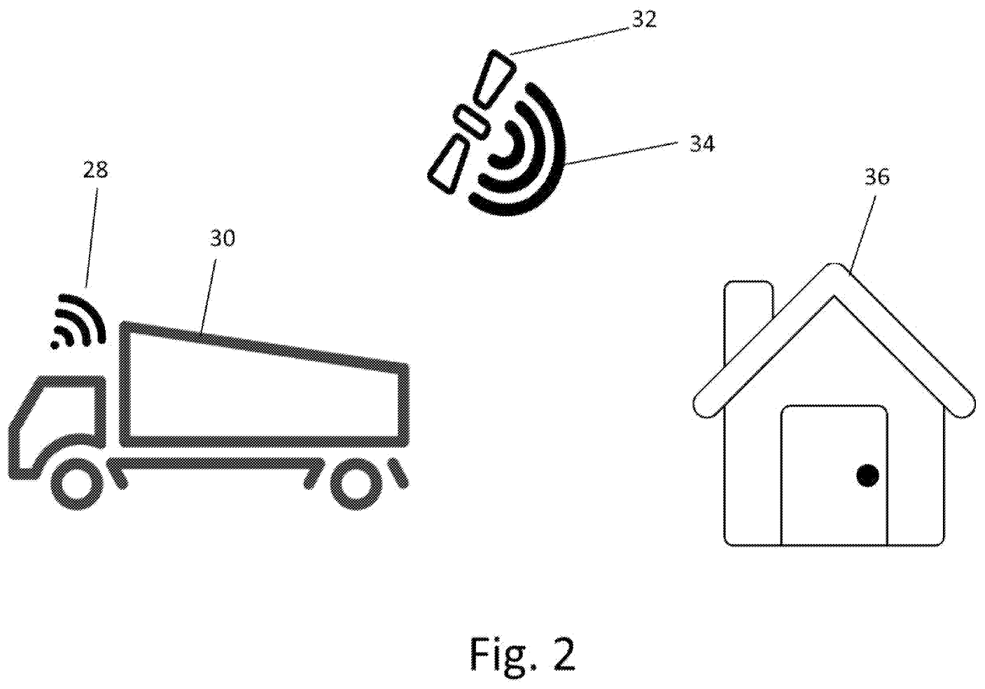

As the driver operates the vehicle the various measuring devices record the information. Looking at FIG. 2, the vehicle 30 is operated and the signal 28 comprising this vehicle information is transmitted to a satellite 32. The satellite 32 relays the information by signal 34 to the base 36 where the information is further processed. It should be appreciated that the satellite 32 is just one communications link possibility. There may be communications used through a cellular network or other means of wireless communication from the vehicle 32 the base 36.

The base 36 represents a processing system remote from the vehicle 30. The base 36 may be in the form of a remote third-party processing service. Alternatively, the base 36 may represent a computer in the control of the owner of the vehicle 30, as contrasted to the operator. Alternatively, the processing power it represented by the base 36 may be self-contained within the vehicle 30. In this scenario the signal 28 to the satellite 32 would be unnecessary.

The base 36 processing the telematics and vehicle information may also use artificial intelligence (AI) to help train the driver to be, more safe and efficient. Artificial intelligence is able to evaluate all of the information and data collected from the vehicle 30 and the driver to determine the best ways to help train the driver to become more efficient.

For example, if the artificial intelligence system determines that a particular driver in a vehicle is consuming too much electrical energy given the topography and nature of the route being driven suggestions can be made to the driver to improve their efficiency.

Artificial intelligence can provide a coaching aspect of the system. Using artificial intelligence applied to the specific data, events and situations derived from the vehicle can create greater safety and higher efficiency in the driver pool. Drivers may be required to interact with responses generated by the artificial intelligence system. The system it may provide real-time suggestion and instructions to help the driver improve their efficiency.

For example drivers may be required to use ear buds or other audio equipment to receive feedback while driving from the system. As a drivers score improves the artificial intelligence may reduce the frequency of corrective feedback provided to the driver. The driver may be immediately rewarded by being provided alternative audio content, such as music. This creates an immediate reward system for the driver to quickly improve their driving score. The audio communication may also provide a direct communication tool between the driver and fleet dispatch services responsible for overseeing that driver.

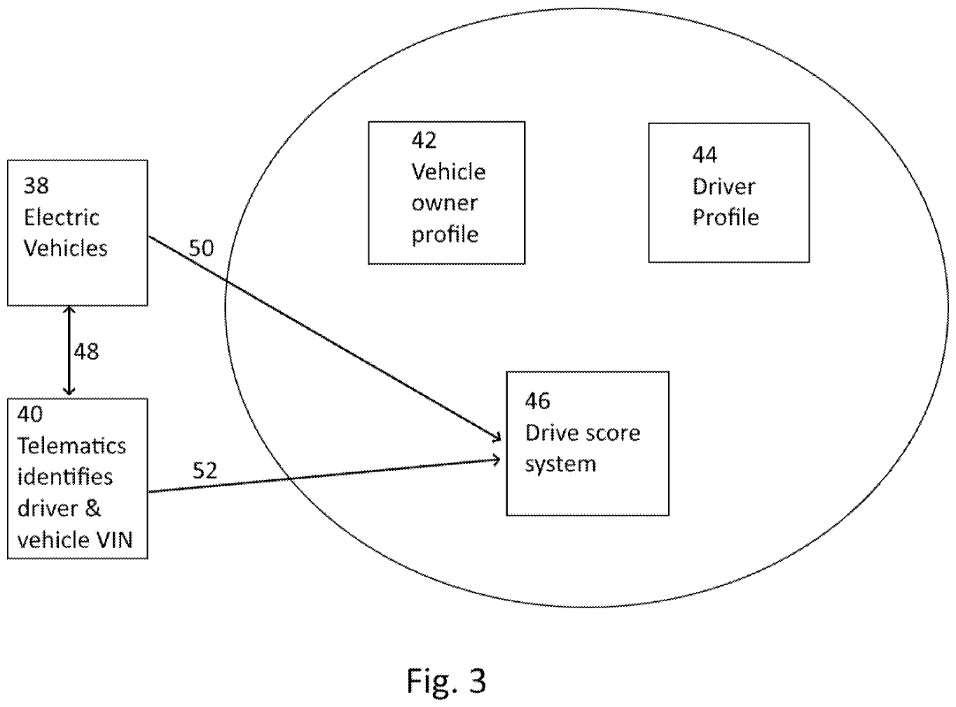

FIG. 3 shows another graphical representation of the elements of an exemplary system. The electric vehicles 38 have a relation 48 to the telematics 40. The telematics 40 identify the particular driver and specific vehicle by vehicle identification number (VIN). The relation 48 between a particular electric vehicle 38 and the telematics 40 may change as either the vehicle or the driver changes.

The relation 50 between the electric vehicle 38 and the drive score system 46 may include information such as speed of the vehicle times and efficiencies of brake regeneration, hard maneuvers and acceleration. The relation 52 between the telematics 40 and drive score system 46 includes, in this example, GPS coordinates and driver identification link to the vehicle.

Using information derived from either or both the GPS and speedometer the driver engagement system can compare the vehicle's actual speed to the posted speed limit for a given section of road. Similarly, the power regenerated through regenerative braking in actual practice can be compared to the expected quantification of recovered electricity through regenerative braking.

Using the optional camera directed toward the driver, the system is able to extrapolate an estimated driver engagement score. The driver engagement score may use factors such as determining the percentage of time that the driver's eyes are facing forward and therefore presumably engaged in safety scanning during the operation of the vehicle. Similarly, monitoring may also be able to show systematic scanning of side and rear view mirrors during a backing up process.

In another example, picking up garbage cans may require a driver to frequently align the pickup arm on the side of the vehicle to the can being picked up. The eye scanning feature can ensure that the speed of the vehicle as it approaches a can pick up is appropriate along with where the driver is shifting their attention focus derived from the direction that their eyes are pointing as seen in the camera.

The drive score system 46 may use vehicle outputs that are linked to geographically based data such as speed limits, topography of the area being driven and other relevant factors to generate an electric vehicle driver performance score. Other factors such as on-time deliveries, safety scores of other drivers in the company fleet or unexpected absences from driving may also affect a driver's performance score.

Another concept of the present invention is that the driver's performance score can be portable. A driver can achieve a performance score in a particular vehicle or for a particular fleet manager and then continue to build on that score for another company. A benefit for a driver may be that a high-performing driver may be able to command an increased salary at another job or may be able to receive advantageous insurance rates.

In most prior art driver monitoring systems the data is collected and owned by the employer. If the employee moves to another company the information relating to the driver's efficiency and skill would be lost to that driver and to the new company. In this sense a very experienced driver at a new company may not have the performance score commensurate with the quality of his driving or his experience.

The system may be integrated with a social media network. For example, driver's may be able to maintain a professional profile that includes their personal information as well as their driving score. This can both encourage and improve driving scores by providing competition between drivers or companies as well as allowing a driver to maintain over a long period the effort they put in to drive more effectively and efficiently in the past.

In this way the drivers own their own profile and performance score. This information can follow the driver from one vehicle to another and from one company to another. The information could further be used for a driver's personal vehicle and the insurance premium rates associated with that vehicle. When the driving score is owned and controlled by the particular individual associated with that score, that driver has increased freedom to move from company to company and to benefit from their superior driving skills. It also allows a company hiring a new driver to have a solid basis for information about that driver before they even begin that new job.

A version of the invention can be fairly described as being driver improvement system comprised of providing a first driver with a vehicle. Then, automatically gathering data about an operational aspect of the vehicle when operated by the first driver. The operational aspect may be selected from any of: a speed, a regenerative braking factor, a hard maneuver, an acceleration factor, a location, a battery charge factor (i.e. not allowing the battery to completely deplete before recharging or a driver engagement factor. Then, calculating a first score relating to the first driver based on the operational aspect. Then, providing the first score to the first driver for permanent retention. Then, comparing the first score to a second score associated with a second driver. Then providing the first driver with a reward only if the first score is greater than the second score. Optionally, the operational aspect is analyzed and real-time feedback is provided to the first driver to improve the first score. Optionally, the reward is any of: an insurance premium deduction, money or free entertainment.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

I/we claim:

1. A driver improvement system comprised of:
providing a first driver with a vehicle;
automatically gathering data about an operational aspect of the vehicle when operated by the first driver;
the operational aspect selected from any of: a speed, a regenerative braking factor, a hard maneuver, an acceleration factor, a location, a battery charge factor or a driver engagement factor;
calculating a first score relating to the first driver based on the operational aspect;
providing the first score to the first driver for permanent retention;
comparing the first score to a second score associated with a second driver;
providing the first driver with a reward only if the first score is greater than the second score.

2. The driver improvement system of claim 1 further characterized in that the operational aspect is analyzed and real-time feedback is provided to the first driver to improve the first score.

3. The driver improvement system of claim 1 further characterized in that the reward is any of: an insurance premium deduction, money or free entertainment.
